(19) United States
(12) Patent Application Publication
(10) Pub. No.: US 2008/0181511 A1
(43) Pub. Date: Jul. 31, 2008

(54) PERSONAL IMAGE AND STYLING SYSTEM AND METHOD

(76) Inventor: Carol Tuttle, Draper, UT (US)

Correspondence Address: GRANT R CLAYTON;CLAYTON HOWARTH & CANNON, PC, P O BOX 1909, SANDY, UT, 84091-1909, US

(21) Appl. No.: 12/021,248

(22) Filed: Jan. 28, 2008

Related U.S. Application Data
(60) Provisional application No. 60/897,713, filed on Jan. 26, 2007.

(51) Int. Cl. G06K 9/62

(52) U.S. Cl. 382/209

(57) ABSTRACT

A system for improving an appearance and image of a human being. The system comprises a plurality of predefined profiles having in common a plurality of characteristics. Each of the predefined profiles has one or more attributes associated with each of the plurality of characteristics. The system may further comprise an evaluation that may be administered to a human subject to thereby determine one or more personal attributes of the human subject. The one or more personal attributes of the human subject, as determined by the evaluation, may be used to match the human subject with one of the predefined profiles. The human subject may then be presented with an appearance enhancement plan corresponding to the predefined profile to which the human subject has been matched.

### CROSS-REFERENCE TO RELATED APPLICATIONS

This application claims the benefit of U.S. Provisional Application No. 60/897,713, filed Jan. 26, 2007, which is hereby incorporated by reference herein in its entirety.

### STATEMENT REGARDING FEDERALLY SPONSORED RESEARCH OR DEVELOPMENT

Not Applicable.

### BACKGROUND

1. The Field of the Disclosure

The present disclosure relates generally to image and appearance enhancement, and more particularly, but not necessarily entirely, to improving a person's appearance and image based upon a profile of the person.

2. Description of Related Art

A person's overall appearance is dictated upon many factors, including, but not limited to, hairstyle, hair color, jewelry, accessories, make-up, and wardrobe. A person's appearance to others may have a dramatic impact on the person's success both in the business world and in a personal life. It has been well documented that improving a person's appearance will in turn increase the person's self-image and self-confidence. In the past, people have gone to great lengths to improve their appearances, including to the point of spending large amounts of money and time to change or improve their appearances. However, while most people understand the importance of projecting a pleasing appearance to others, few of them are able to effectively do so on a regular basis.

In the past, many attempts have been made to develop suitable methods for improving a person's overall appearance. Fashion magazines and other publications are full of advice on improving one's appearance. In addition, with the advent of the Internet scores of web sites became available for providing fashion and wardrobe tips. However, while these resources, and others, may be beneficial to provide general advice on improving one's appearance, the advice is not typically tailored to the particular individual. That is, while a suggested appearance improvement tip may be suitable for some individuals, it may not be suitable for other individuals. For example, while a suggested color of clothing may improve the appearance of one person, it may detract from the appearance of another person.

Despite the advantages of known methods and processes, improvements are still being sought in the art. The prior art is thus characterized by several disadvantages that are addressed by the present invention. The present invention minimizes, and in some aspects eliminates, the above-mentioned failures, and other problems, by utilizing the methods and structural features described herein.

The features and advantages of the invention will be set forth in the description which follows, and in part will be apparent from this description, or may be learned by the practice of the invention without undue experimentation. The features and advantages of the invention may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 depicts Table 1 containing information on the physical features of Type 1, Type 2, Type 3, and Type 4 profile classifications;

FIG. 2 depicts Table 2 containing information on the body language of Type 1, Type 2, Type 3, and Type 4 profile classifications;

FIG. 3 depicts Table 3 containing information on the behavioral tendencies and personalities of Type 1, Type 2, Type 3, and Type 4 profile classifications;

FIG. 4 depicts Table 4 containing information on the gifts and talents of Type 1, Type 2, Type 3, and Type 4 profile classifications;

FIG. 5 depicts Table 5 containing information on the brain and thought processes of Type 1, Type 2, Type 3, and Type 4 profile classifications;

FIG. 6 depicts Table 6 containing general information on the Type 1 profile classification;

FIG. 7 depicts Table 7 containing general information on the Type 2 profile classification;

FIG. 8 depicts Table 8 containing general information on the Type 3 profile classification;

FIG. 9 depicts Table 9 containing general information on the Type 4 profile classification;

FIG. 10 depicts Table 10 containing information on the skin assessment of Type 1, Type 2, Type 3, and Type 4 profile classifications;

FIG. 11 depicts Table 11 containing information on the energy of each of the Type 1, Type 2, Type 3, and Type 4 profile classifications;

FIG. 12 depicts Table 12 containing exemplary descriptive words for each of the Type 1, Type 2, Type 3, and Type 4 profile classifications;

FIG. 13 depicts Table 13 containing exemplary descriptive shapes for each of the Type 1, Type 2, Type 3, and Type 4 profile classifications;

FIG. 14 depicts Table 14 containing information on the energy movement for each of the Type 1, Type 2, Type 3, and Type 4 profile classifications;

FIG. 15 depicts Table 15 containing information on the YING/YANG relationship of each of the Type 1, Type 2, Type 3, and Type 4 profile classifications;

FIG. 16 depicts Table 16 containing information on the nature equivalents for each of the Type 1, Type 2, Type 3, and Type 4 profile classifications;

FIGS. 17A and 17B depict Tables 17A and 17B, respectively, containing information on appearance enhancement plans for each of the Type 1, Type 2, Type 3, and Type 4 profile classifications;

FIG. 18 depicts Table 18 containing information on hairstyles and coloring for each of the Type 1, Type 2, Type 3, and Type 4 profile classifications;

FIGS. 19A and 19B depict Tables 19A and 19B, respectively, containing information on make-up for each of the Type 1, Type 2, Type 3, and Type 4 profile classifications;

FIGS. 20A and 20B depict Tables 20A and 20B, respectively, containing information on accessories for each of the Type 1, Type 2, Type 3, and Type 4 profile classifications;

FIGS. 21A and 22B depict Tables 21A and 22B, respectively, containing information on jewelry for each of the Type 1, Type 2, Type 3, and Type 4 profile classifications; and

FIG. 22 is a flow diagram pursuant to an embodiment of the present disclosure.

### DETAILED DESCRIPTION

For the purposes of promoting an understanding of the principles in accordance with the disclosure, reference will now be made to the illustrative embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. As used herein, the terms “comprising,” “including,” “containing,” “characterized by,” and grammatical equivalents thereof are inclusive or open-ended terms that do not exclude additional, unrecited elements or method steps. Further, as used herein, the term “subject” refers to a human being whose image and appearance are desired to be improved.

Applicant has developed novel methods and processes that are able to improve a subject's appearance and image based upon comprehensive profile information gathered about the subject. The comprehensive profile information includes, but is not limited to, a combination of one or more quantifiable characteristics and/or attributes of the subject. In order to gather information about a subject's profile, the subject may undergo an evaluation or observation. In an embodiment of the present disclosure, the evaluation is largely a self-evaluation in order to obtain the most accurate results about the subject's profile information. Once gathered, the subject's profile information is used to classify the subject into at least one of a group of predefined profiles.

Each of the predefined profiles may have a corresponding appearance enhancement plan associated therewith. An appearance enhancement plan comprises a plurality of recommendations and guidelines for improving an appearance of a human being. Thus, once the subject's profile information has been matched to one of the predefined profiles, the subject is able to apply the corresponding appearance enhancement plan of the predefined profile to which the subject has been matched to thereby improve the subject's overall appearance and image. In this manner, the subject is able to follow the set plan when making decisions that will bear upon the subject's appearance. For example, following the applicable appearance enhancement plan, decisions about what type of clothing to wear are made easier.

Applicant has further developed a system for matching a subject's profile information to one of a group of predefined profiles. In particular, each of the predefined profiles is defined by a plurality of quantifiable characteristics, including, but not limited to, physical, behavioral, and mental characteristics. The system further includes an evaluation to thereby gather information from a subject regarding the subject's own profile information. Once a subject's profile information has been gathered, the subject's profile information is compared to the known profile information for each of the predefined profiles to thereby find at least one matching predefined profile applicable to the subject. The subject may then improve his or her appearance by following an appearance enhancement plan dictated by the predefined profile to which the subject has been matched.

It will be appreciated that the subject's profile information as determined from the evaluation need not match exactly to all of the profile information for a given predefined profile in order to find a “match.” In fact, a particular subject may be matched to a dominant predefined profile and a subordinate predefined profile using the subject's profile information. The dominant predefined profile is the predefined profile whose defining characteristics and attributes most closely match the subject's profile information, and the subordinate predefined profile is the predefined profile whose defining characteristics and attributes most closely match the subject's profile information after the dominate predefined profile.

As discussed above, each of the predefined profiles is defined by a set of common characteristics, each of the characteristics having a set of attributes. A characteristic of a predefined profile may be those things, features and traits in common among human beings. For example, a characteristic may include the physical features of a human being, such as a face shape. An attribute of a characteristic is that element which is different among the different predefined profiles. That is, the attributes of a given characteristic will vary across the different predefined profiles. For example, in the case of face shape, one predefined profile may be characterized by one particular face shape while another may have a different face shape. The attributes of each of the predefined profiles for a given characteristic may be unique.

The common characteristics of the predefined profiles may include, but are not limited to, the following general categories: physical features, body language, behavioral tendencies and personality, gifts and talents, and brain and thought processes. Each of these will now be explained in more detail.

The physical features category of a predefined profile may include information on the following characteristics: skin and texture, face shape, cheeks, noses, mouth, eyebrows, eyes, and hands. The body language category of a predefined profile may include information on the following characteristics: walking, sitting/standing, voice/language, doodling, and personal space. The behavioral tendencies and personality category of a predefined profile may include information on the following characteristics: likes and dislikes, social interaction skills, thought processes, and attitudes. The gifts and talents category of a predefined profile may include information on the following characteristics: a person's inherent skills for accomplishing goals and tasks. The brain and thought processes category of a predefined profile may include information on the following characteristics: a person's thinking patterns when faced with a challenge or crisis. From the above, it will be appreciated that each of the predefined profiles represents a comprehensive profile of various aspects of a human being.

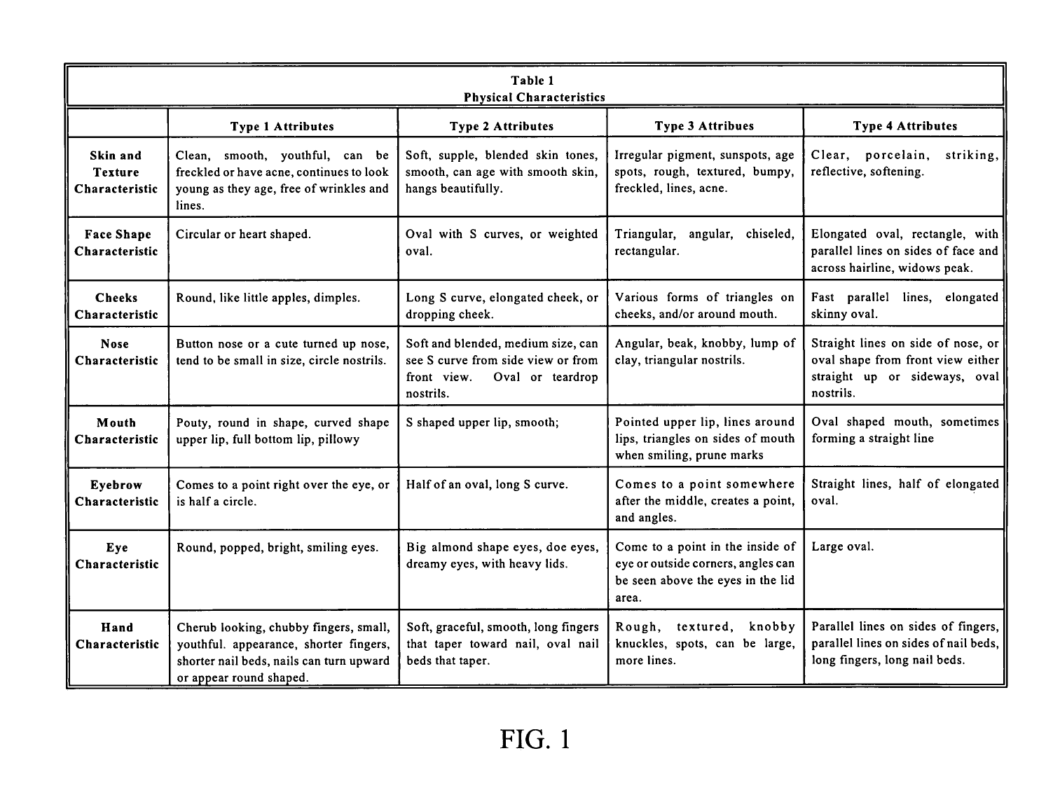

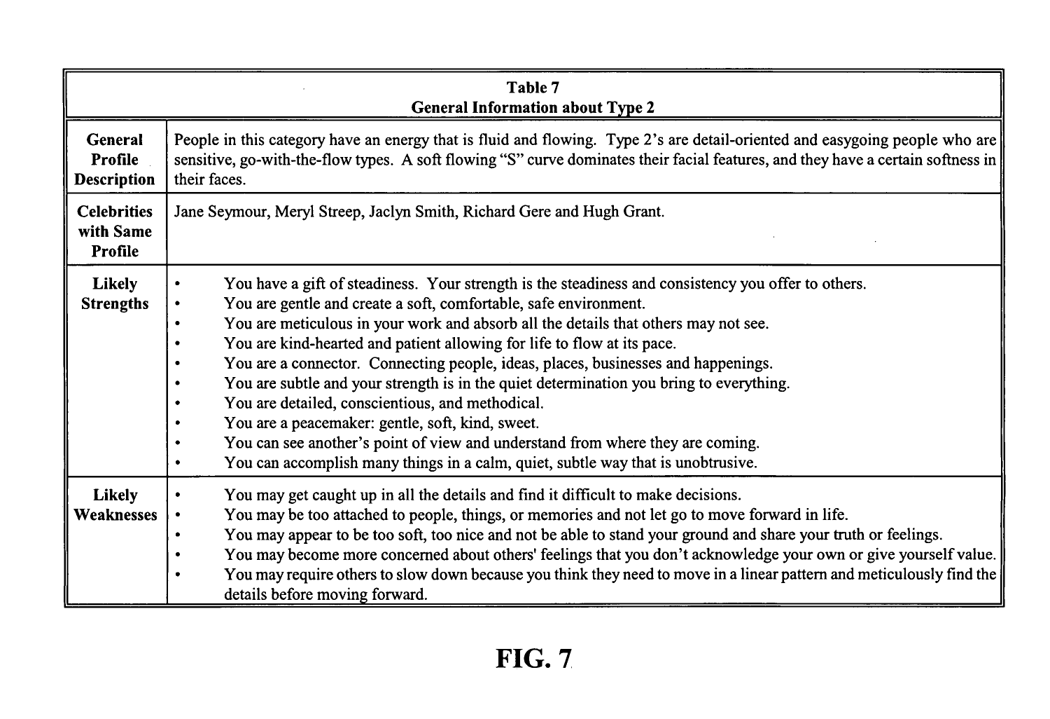

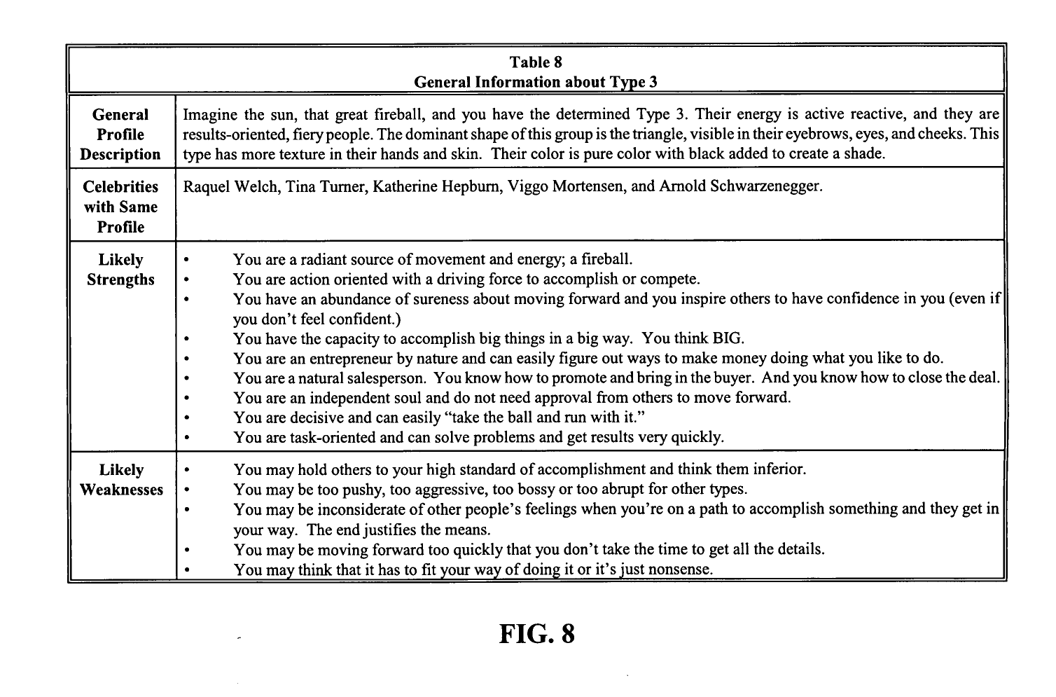

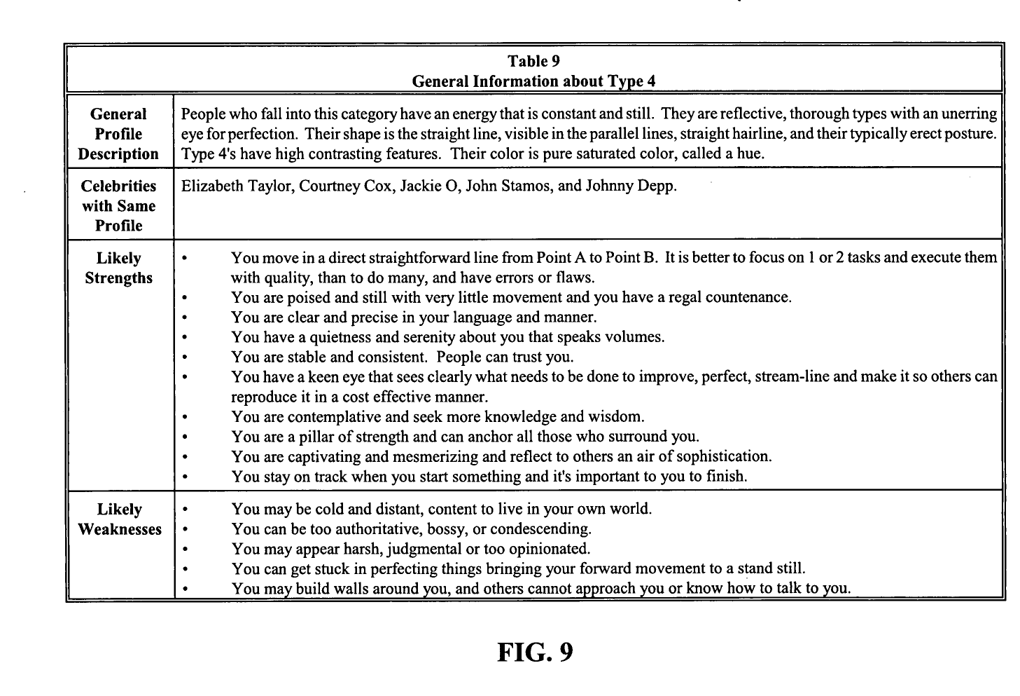

A group of predefined profiles pursuant to the present disclosure may comprise four distinct predefined profiles that will be referred to herein as Type 1, Type 2, Type 3 and Type 4 profile classifications. It will be appreciated however, that any number of predefined profiles may be created within the scope of the present disclosure. The common characteristics of the Type 1, Type 2, Type 3 and Type 4 profile classifications, and their corresponding individual attributes, are set forth in the Tables 1-10 as shown FIGS. 1-10, respectively.

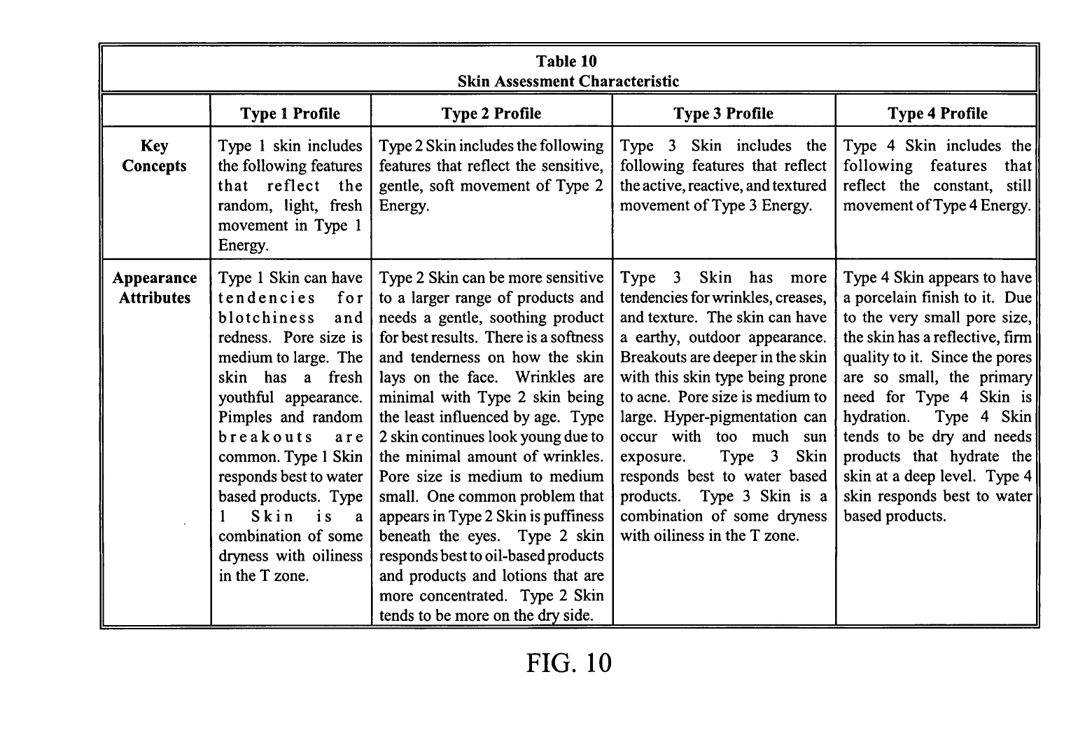

Table 1, as shown in FIG. 1, lists the common physical characteristics for the Type 1, Type 2, Type 3, and Type 4 profile classifications. The physical characteristics listed in Table 1 include, but are not limited to, the following: skin and texture, face shape, cheeks, nose, eyebrows, eyes, and hands. The distinguishing attributes for each of the Type 1, Type 2, Type 3, and Type 4 profile classifications are also listed in Table 1 for each of the physical characteristics. In addition, Table 10, as shown in FIG. 10, provides additional information about the skin for each of the Type 1, Type 2, Type 3, and Type 4 profile classifications. This additional information may include, but is not limited to, the following: key concepts about the skin of a given predefined profile, and skin appearance attributes.

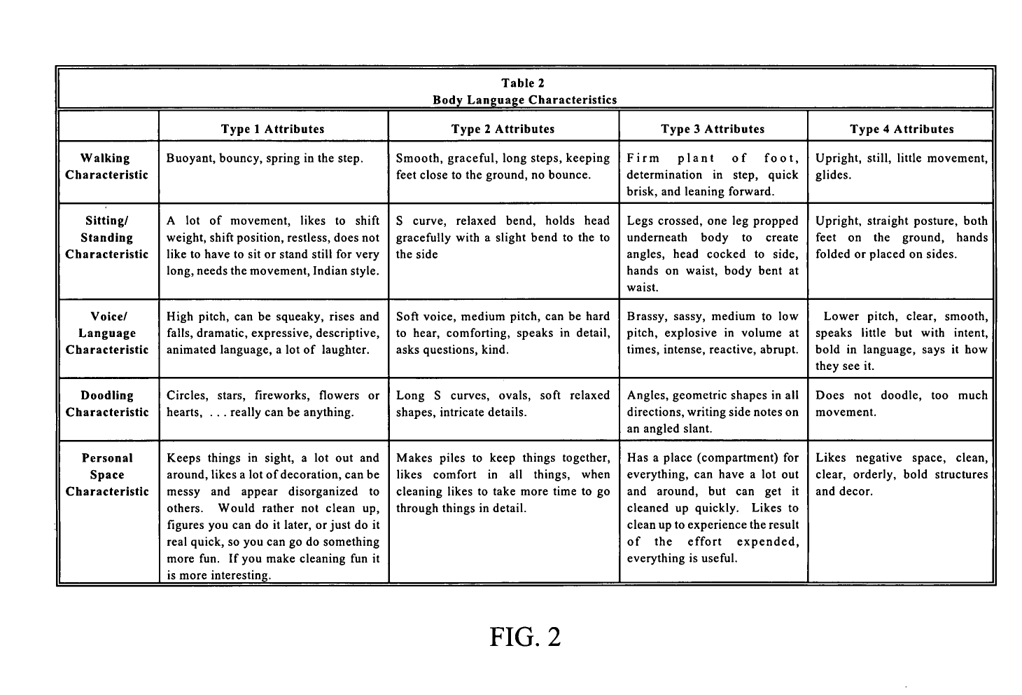

Table 2, as shown in FIG. 2, includes the common body language characteristics for the Type 1, Type 2, Type 3, and Type 4 profile classifications. The body language characteristics listed in Table 2 include, but are not limited to, the following: walking, sitting/standing, voice/language, doodling, and personal space. The distinguishing attributes for each of the Type 1, Type 2, Type 3, and Type 4 profile classifications are also listed in Table 2 for each of the body language characteristics.

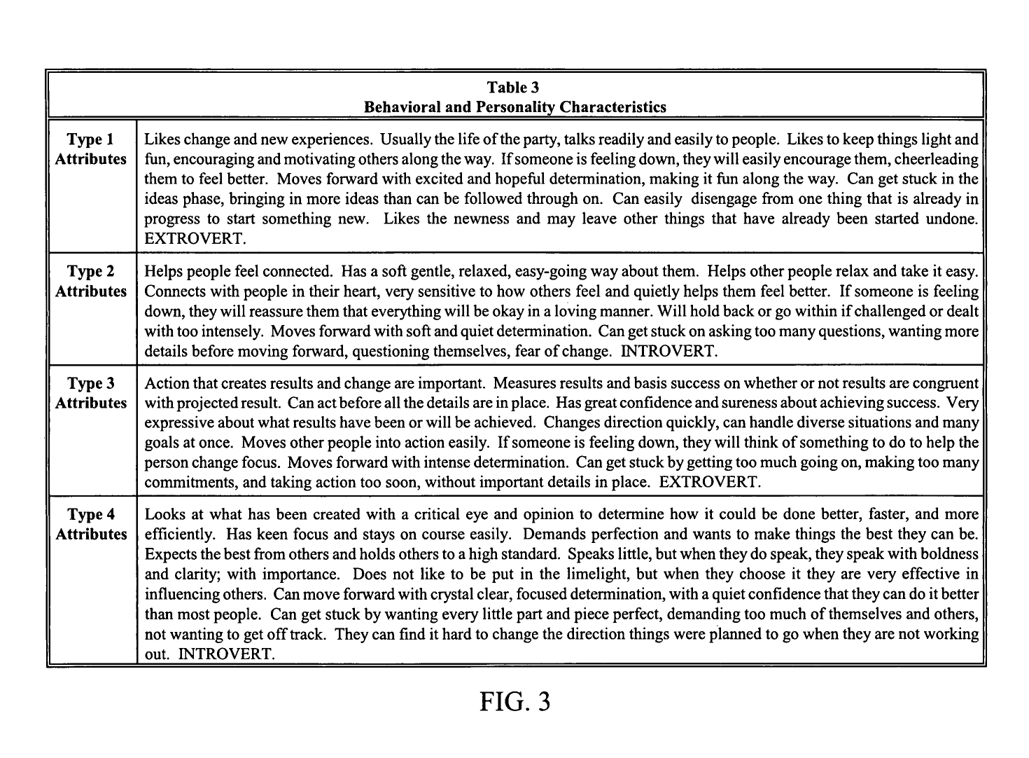

Table 3, as shown in FIG. 3, includes the common behavioral tendencies and personality characteristics for the Type 1, Type 2, Type 3, and Type 4 profile classifications. The behavioral tendencies and personality characteristics may include, but are not limited to, the following: reactions to changes and new experiences, social interaction skills, goal accomplishment skills, general attitudes in crisis situations, comforting skills, multi-tasking abilities, manners and methods of measuring success, determination levels, and abilities to change direction on a project. The distinguishing attributes for each of the Type 1, Type 2, Type 3, and Type 4 profile classifications are also listed in Table 3 for the behavioral tendencies and personality characteristics.

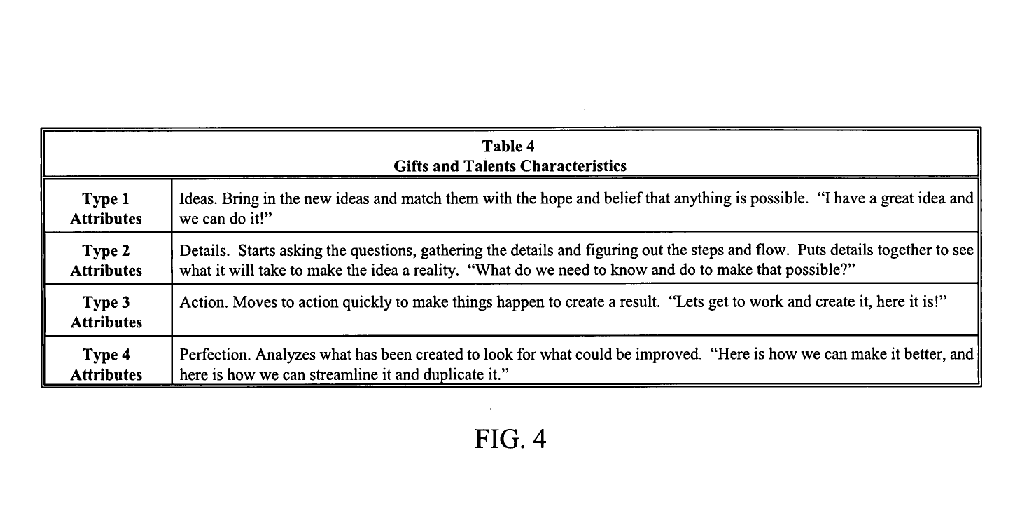

Table 4, as shown in FIG. 4, includes the common gifts and talents characteristics for the Type 1, Type 2, Type 3, and Type 4 profile classifications. These gifts and talents characteristics may include, but are not limited to, the following: abilities to bring new ideas, detail orientation skills, task accomplishment skills, and problem solving skills. The distinguishing attributes for each of the Type 1, Type 2, Type 3, and Type 4 profile classifications are also listed in Table 4 for the gifts and talents characteristics.

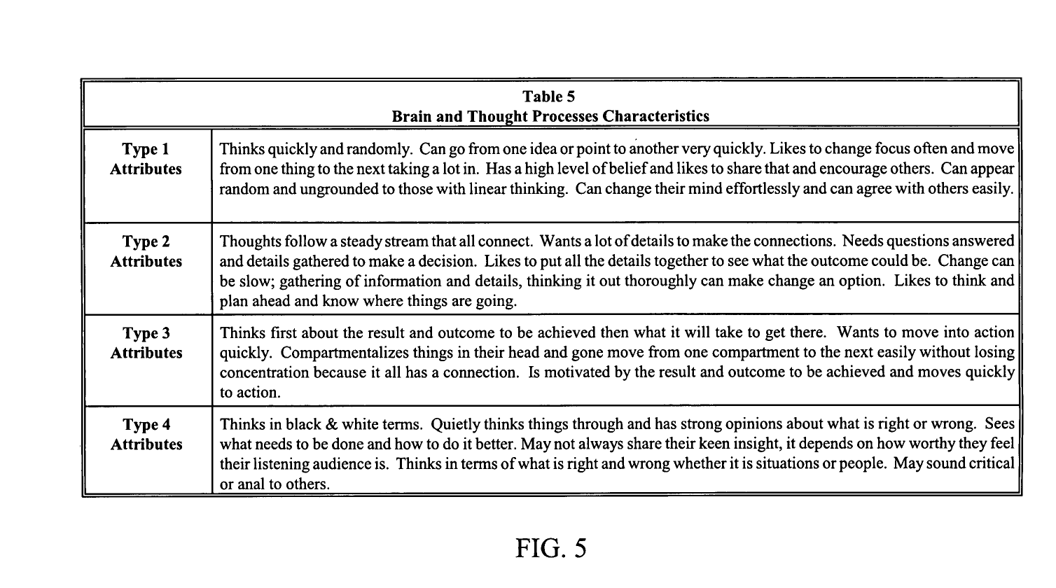

Table 5, as shown in FIG. 5, includes the common brain and though processes characteristics for each of the Type 1, Type 2, Type 3, and Type 4 profile classifications. The brain and thought processes characteristics may include, but are not limited to, the following: thinking patterns, thought streams, concentration abilities, and abilities to stay on task. The distinguishing attributes for each of the Type 1, Type 2, Type 3, and Type 4 profile classifications are also listed in Table 5 for the common brain and though processes characteristics.

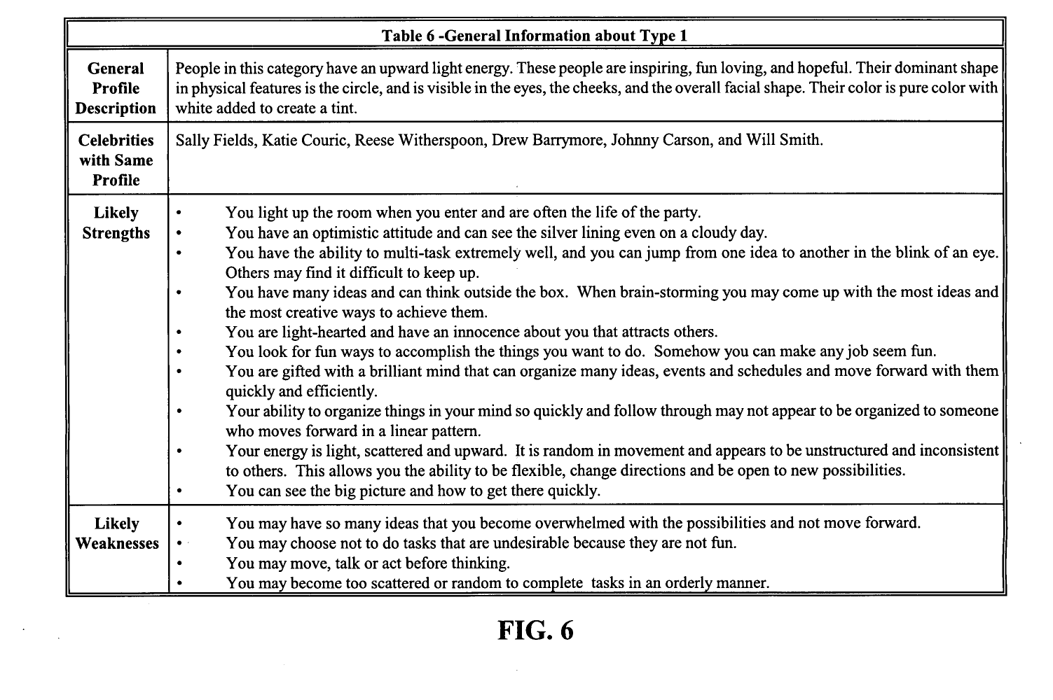

Tables 6-9, as shown in FIGS. 6-9, respectively, each provides additional information about each of the Type 1, Type 2, Type 3, and Type 4 profile classifications. This additional information may include, but is not limited to, the following for each of the profile classifications: a general profile description, celebrities with the same profile, and the likely strengths and weaknesses of a profile. As will be explained hereinafter in more detail, the information in Tables 6-9 may be utilized to help a subject to develop a greater understanding of the Type 1, Type 2, Type 3, and Type 4 profile classifications. Moreover, it will be appreciated by those skilled in the art that the celebrities identified in FIG. 6 will be changed from time-to-time to accommodate changes in culture and different cultures.

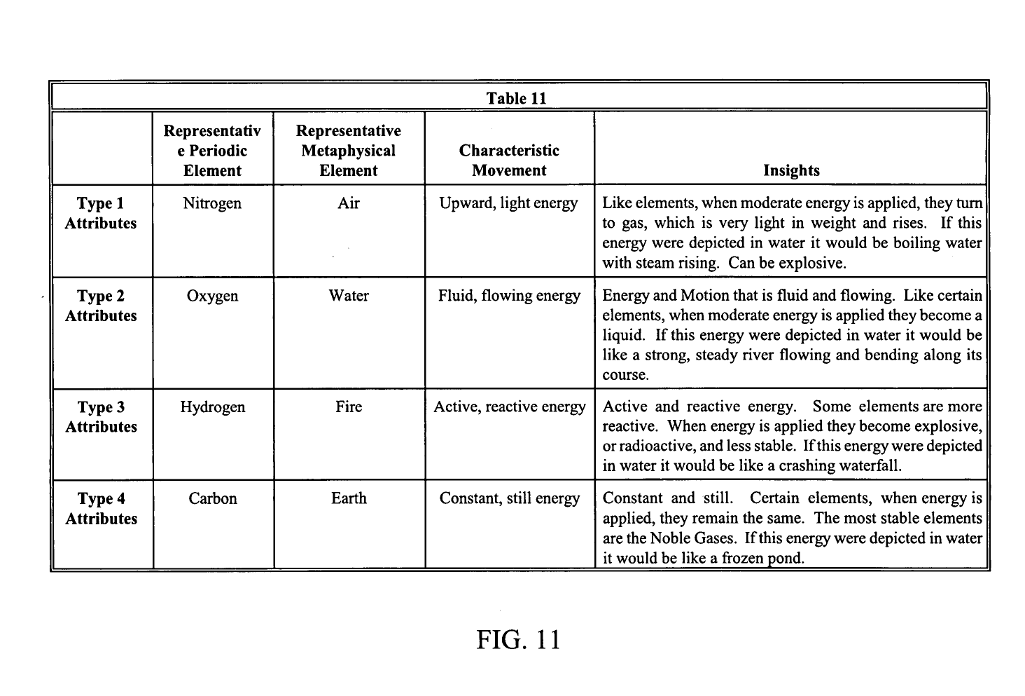

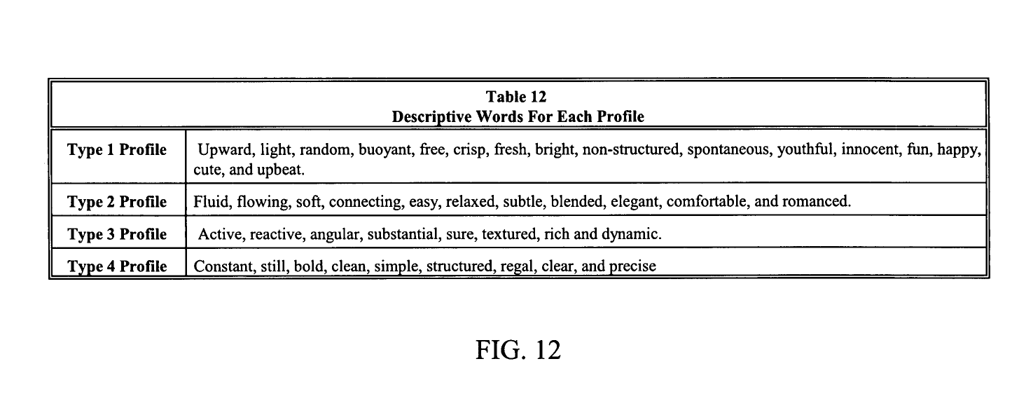

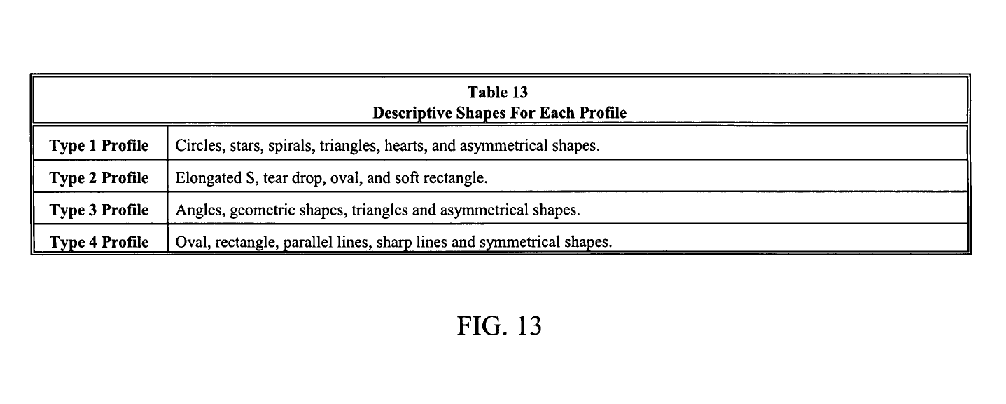

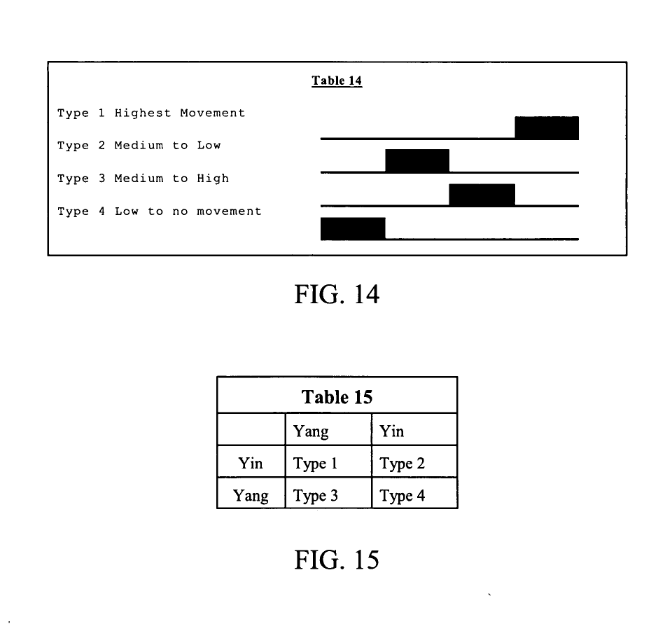

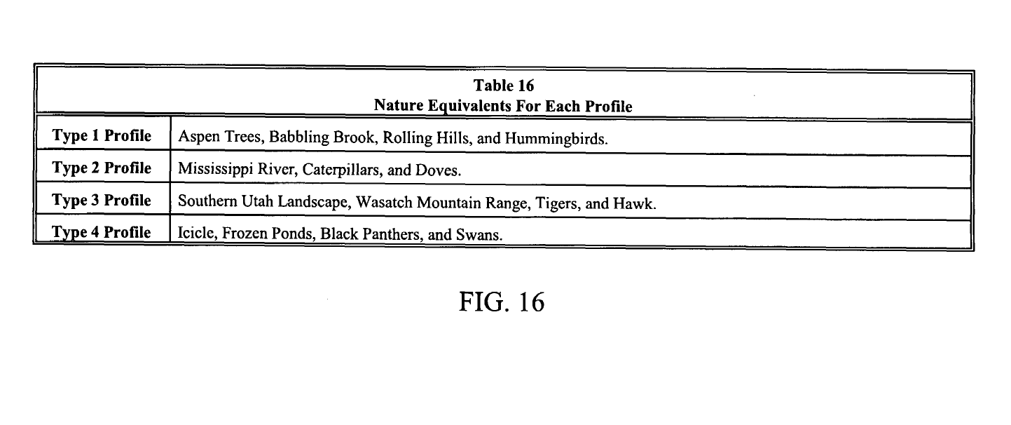

Tables 11-16, as shown in FIGS. 11-16, respectively, provide additional information about each of the Type 1, Type 2, Type 3, and Type 4 profile classifications. Table 11, as shown in FIG. 11, provides information for each of the Type 1, Type 2, Type 3, and Type 4 profile classifications regarding the following: a representative periodic element, a representative metaphysical element, a representative characteristic movement, and profile insights. Table 12, as shown in FIG. 12, provides information on descriptive words for each of the Type 1, Type 2, Type 3, and Type 4 profile classifications. Table 13, as shown in FIG. 13, provides exemplary descriptive words for each of the Type 1, Type 2, Type 3, and Type 4 profile classifications. Table 14, as shown in FIG. 14, provides an energy movement diagram for each of the Type 1, Type 2, Type 3, and Type 4 profile classifications. Table 15, as shown in FIG. 15, provides the YIN/YANG relationship between each of the Type 1, Type 2, Type 3, and Type 4 profile classifications. Table 16, as shown in FIG. 16, provides information on the relationship between the Type 1, Type 2, Type 3, and Type 4 profile classifications and things in nature. As will be explained in more detail below, the information contained in Tables 11-16 is also useful to facilitate a subject's understanding of the Type 1, Type 2, Type 3, and Type 4 profile classifications.

As previously mentioned, each of the predefined profiles, namely, the Type 1, Type 2, Type 3 and Type 4 profile classifications, is associated with an appearance enhancement plan. Each appearance enhancement plan may comprise five core elements for the various aspects of a subject's appearance and image, including, but not limited to, the following: design lines, textures, fabrication, pattern, and color. Each of these concepts is explained below.

Design line—The shapes of the lines of the clothes in the cut, collar, lapels, necklines, jacket bottoms, skirt shapes, and pant shapes. Design lines are applied to clothes, jewelry, accessories, purses, and eyeglasses.

Fabric Texture—The surface of the fabric from smooth and slick to very bumpy. Weight and weave influence texture. It is the finish of the fabric.

Fabrication—The fall and lay of the fabric from soft, subtle, relaxed fabrics to stiff, structured, and stylized fabrics.

Pattern—Bold, large, dramatic, high contrast, distinct, large stripes of only two colors, evenly placed, large, bold checks. The design that is woven into or printed onto the fabric.

Color—The color of the garment.

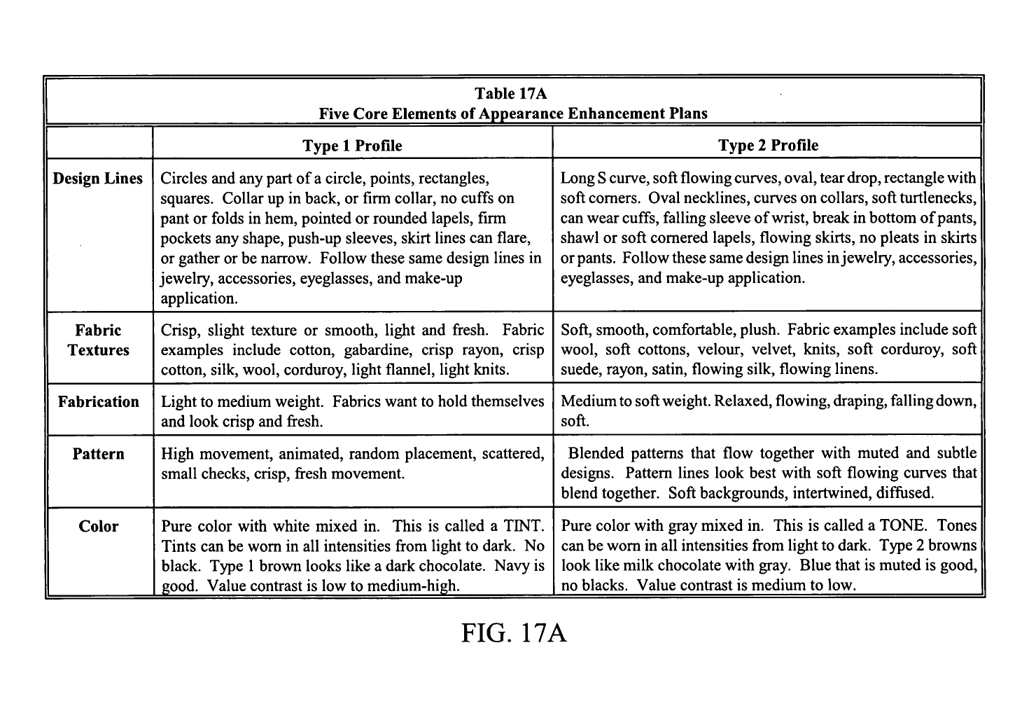

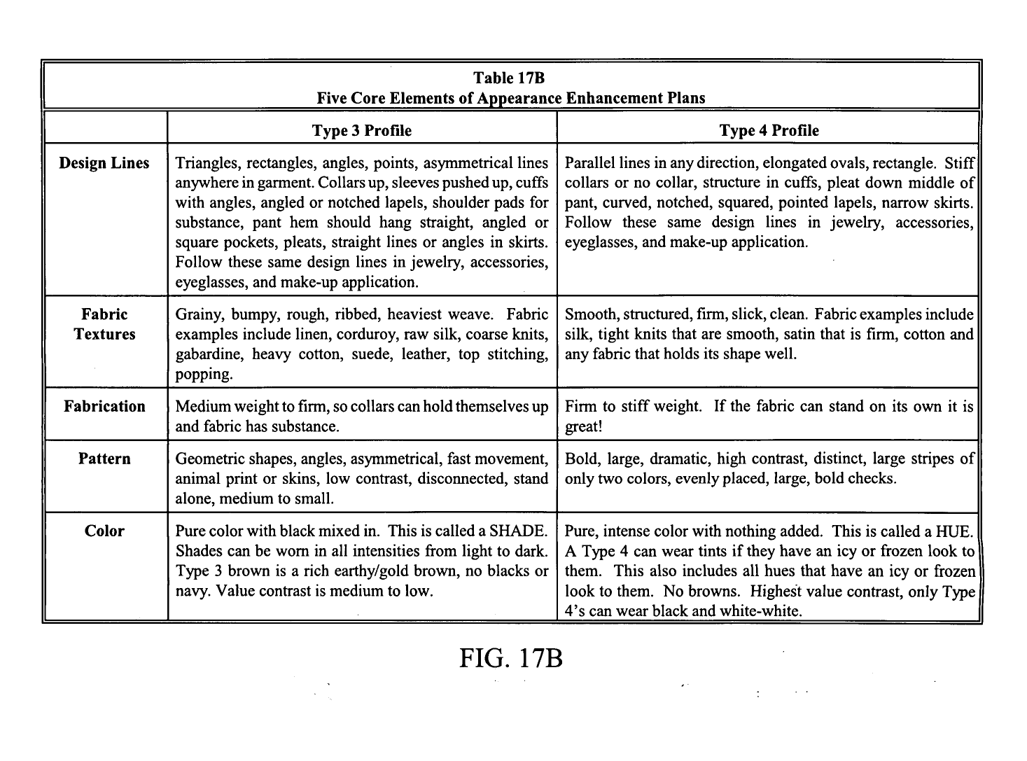

It will be appreciated that each predefined profile has its own ideal design line, fabric texture, fabrication, pattern and color as set forth in its corresponding appearance enhancement plan. The above five core elements may be applied to various aspects of a subject's appearance, including, but not limited to, the following: articles of clothing, hair, make-up, accessories, and jewelry. Tables 17A and 17B, as shown in FIGS. 17A and 17B, respectively, describe each of the five core elements for each of the Type 1, Type 2, Type 3 and Type 4 profile classifications.

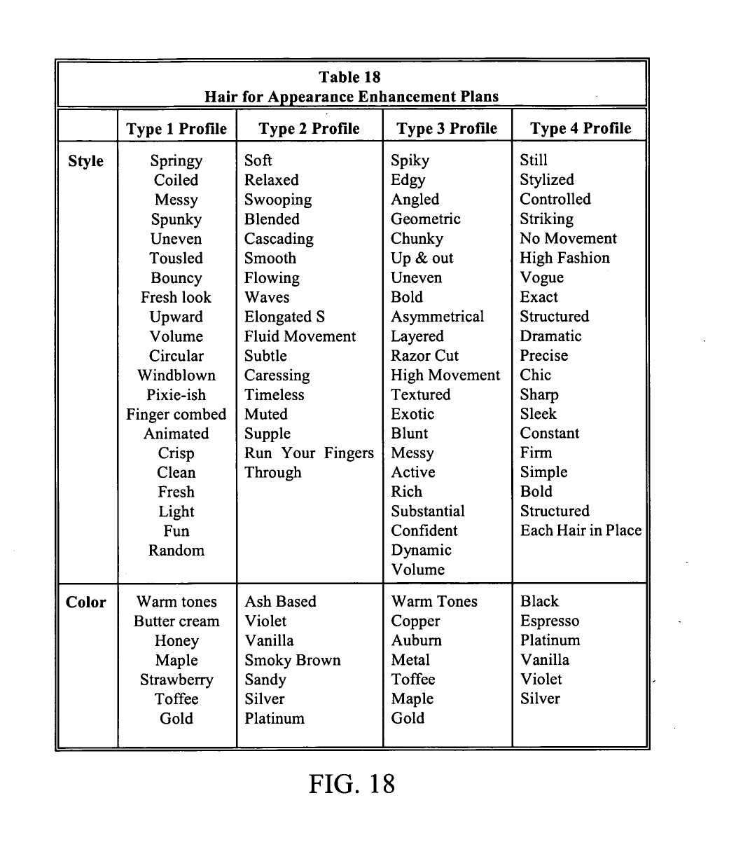

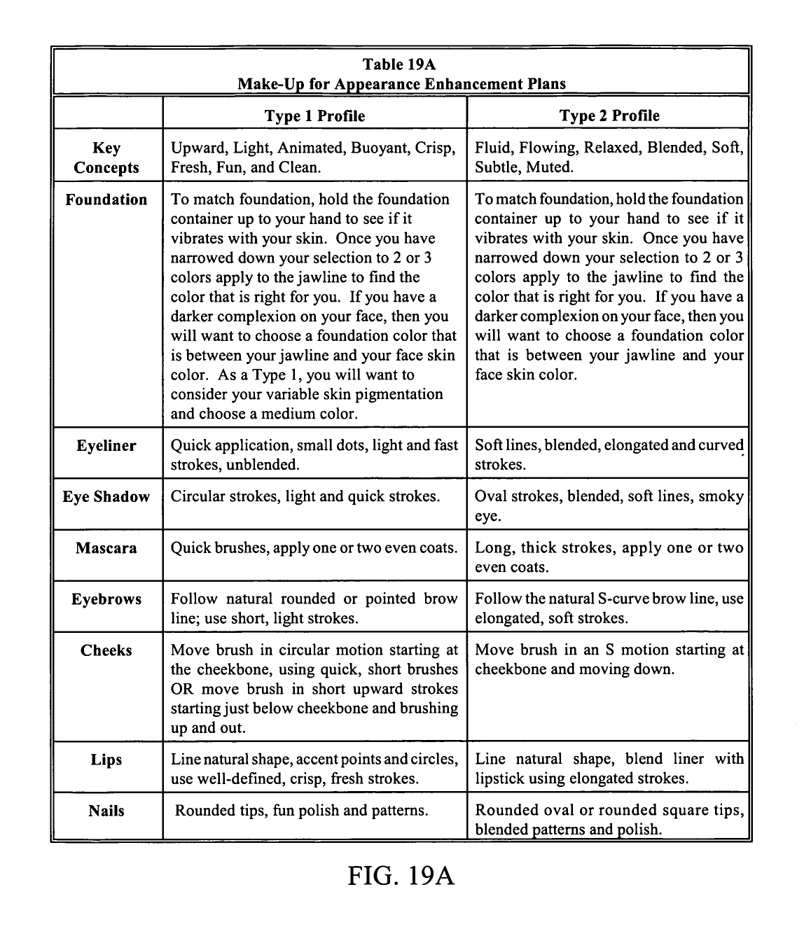

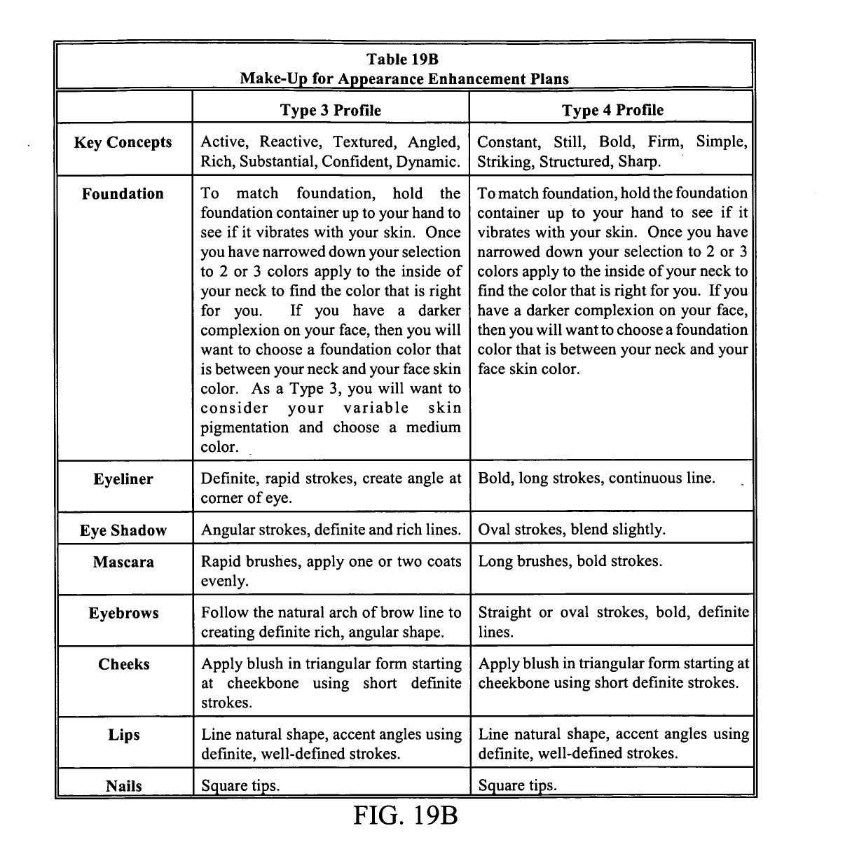

Table 18, as shown in FIG. 18, provides information on recommended hairstyles and colors for each of the Type 1, Type 2, Type 3 and Type 4 profile classifications. Tables 19A and 19B, as shown in FIGS. 19A and 19B, respectively, provide information on recommended make-up for each of the Type 1, Type 2, Type 3 and Type 4 profile classifications. In particular, Tables 19A and 19B provide the following information on make-up for each of the profile classifications: key concepts, foundation, eyeliner, eye shadow, mascara, eyebrows, cheeks, lips and nails.

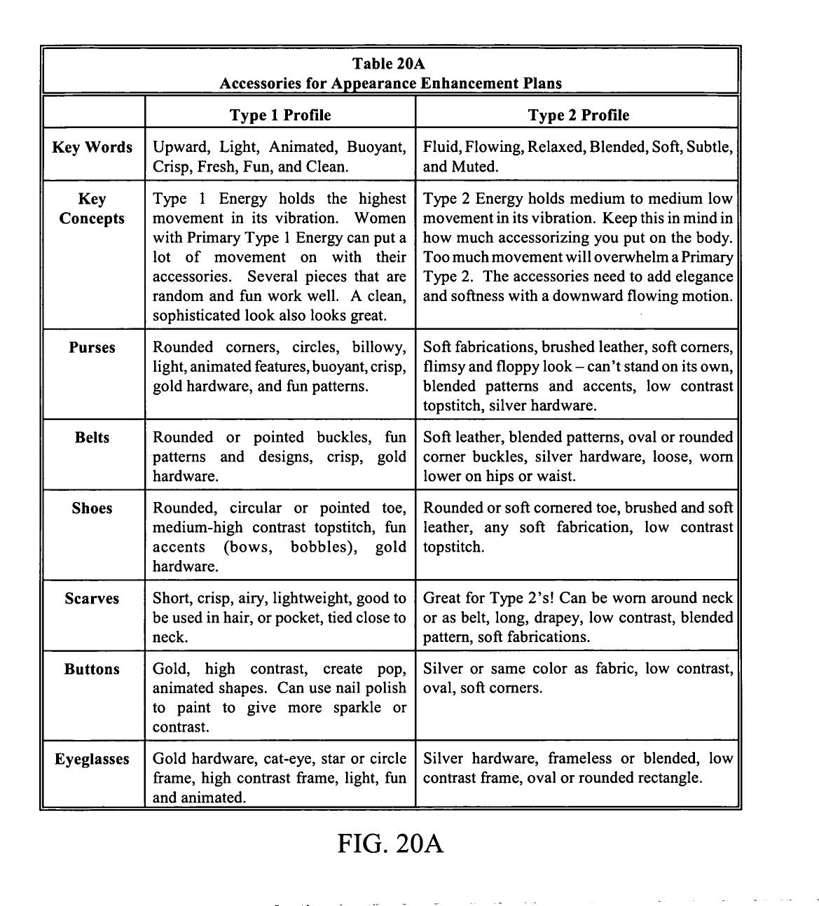

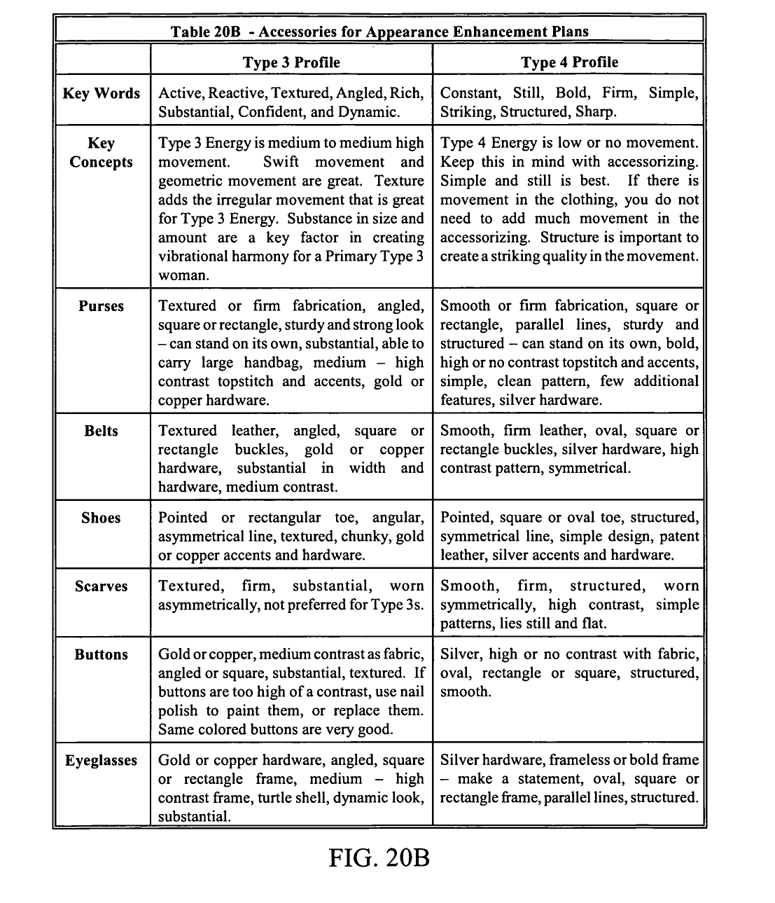

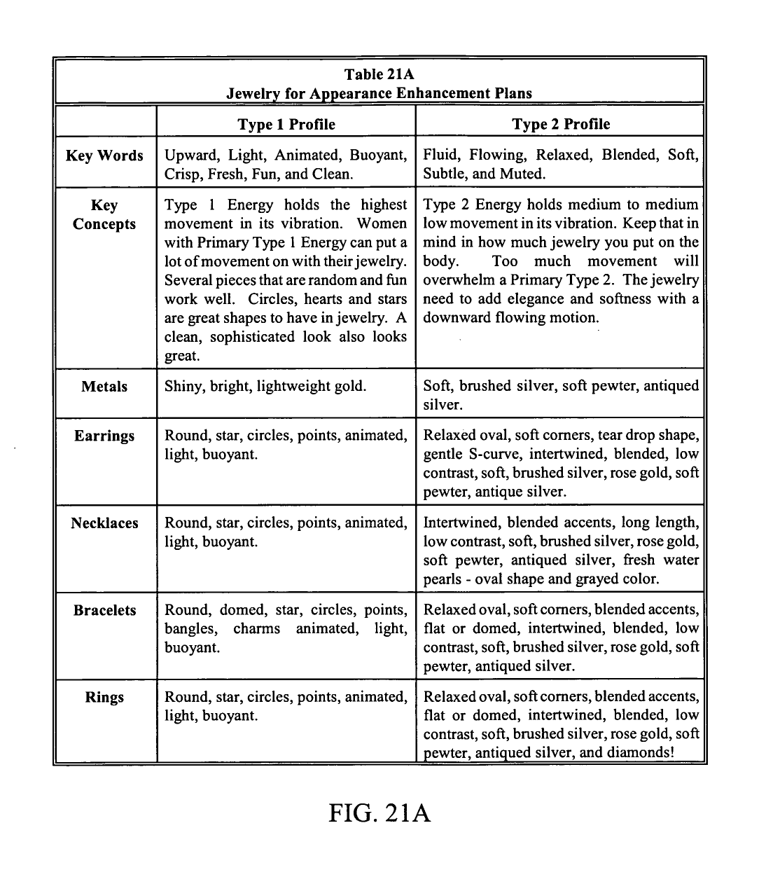

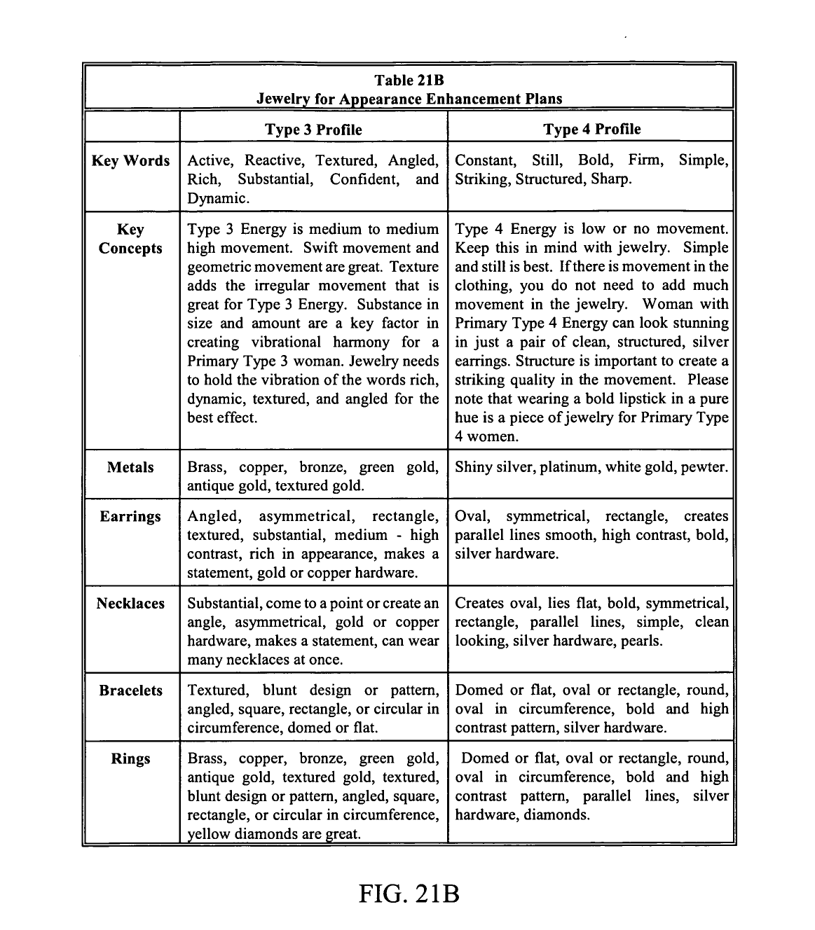

Tables 20A and 20B, as shown in FIGS. 20A and 20B, provide information on recommended accessories for each of the Type 1, Type 2, Type 3 and Type 4 profile classifications. In particular, Tables 20A and 20B provide the following information on accessories for each of the Type 1, Type 2, Type 3 and Type 4 profile classifications: key words, key concepts, purses, belts, shoes, scarves, buttons, and eyeglasses. Tables 21A and 21B, as shown in FIGS. 21A and 21B, respectively, provide information on recommended jewelry for each of the Type 1, Type 2, Type 3 and Type 4 profile classifications. In particular, Tables 21A and 21B provide the following information on accessories for each of the Type 1, Type 2, Type 3 and Type 4 profile classifications: key words, key concepts, metals, earrings, necklaces, bracelets, and rings.

As will now be explained in more detail, an illustrative embodiment of the present disclosure includes comparing a subject's profile information to the attributes of the predefined profiles as set forth in Tables 1-10 to thereby find a matching predefined profile for the subject. It will be appreciated that a subject's profile information may include the subject's particular attributes for the given set of characteristics that define the predefined profiles.

The process of classifying the subject into one of the predefined profiles may include gathering information about the subject's own attributes for a given set of characteristics and then comparing the information to the attribute information in Tables 1-10. As mentioned previously, the subject's personal attributes are unlikely to match every attribute of one of the predefined profiles. In addition, the information in Tables 11-16 may be utilized as tools to help subjects to understand each of the predefined profiles and the classification process.

Once a subject's attributes have been matched to the attributes of one of the predefined profiles, the corresponding information for the predefined profile to which the subject has been matched, as seen in Tables 17-21, may be utilized to form an appropriate appearance enhancement plan for the subject. For example, if a subject's attributes are determined to match most closely the attributes of Type 1, the subject's appearance enhancement plan may include the information listed in Tables 17-21 for Type 1.

An illustrative embodiment of the present disclosure includes determining the subject's attributes through at least one of: observation, evaluation and/or by administering a self-evaluation test to the subject. In an illustrative embodiment of the present disclosure, the observation may be conducted by a trained observer or a group of trained observers to determine the subject's profile information. Using the information provided herein, those skilled in the art will readily be able to train one or more observers to implement many different particular embodiments of the present disclosure.

The self-evaluation may be administered in writing, orally or even via a computer to a subject. For example, the self-evaluation may be administered via the Internet with the subject accessing a website with the self-evaluation through a web browser. Alternatively, the self-evaluation may be administered to the subject orally or in writing.

The self-evaluation administered to the subject should be structured in such a manner as to elicit the necessary information that will enable the subject's personal attributes to be compared to the attributes of the predefined profiles. One suitable method is to administer the self-evaluation in the form of a multiple choice test to the subject. The questions on the multiple choice test may be structured so as to allow the subject to choose between four choices for a given characteristic, where each of the four choices corresponds to the attribute for one of the predefined profiles. Using this approach, a subject may be questioned on each of the characteristics of the predefined profiles. It will be appreciated, however, that a subject need not be tested on all of the characteristics of the predefined profiles.

Table 22, below, comprises exemplary questions that may be used in a self-evaluation that is administered to a subject in order to determine the subject's own profile, i.e., the subject's attributes.

TABLE 22

| | |
|---|---|
| 1. | Which of the below best describes your face shape? |
| a) | Round or heart-shaped |
| b) | Oval, with very blended features |
| c) | Angular, chiseled, very little softness |
| d) | Symmetrical, oval, parallel lines |
| 2. | Which of the below best describes the pigmentation of your |
| | skin? |
| a) | Clear, transparent, whiteness or brightness showing through |
| b) | Even, smooth, porcelain |
| c) | Most unevenness, spots, eruptions, lines, texture, big |
| | pores |
| d) | Light hair - dark skin OR dark hair - light skin (high |
| | contrast) |
| 3. | Which of the below best describes your skin texture? |
| a) | Smooth, possibly with freckles |
| b) | Very soft flowing, creamy, fine texture |
| c) | Defined lines, wrinkles, freckles, discoloration, textured |
| d) | Striking looking skin, mannequin-like, smooth porcelain |
| 4. | Which of the below best describes your cheeks? |
| a) | Round circles right under the eye |
| b) | A long smooth oval, dripping down the face, blended |
| c) | Angular cheeks, with lines separating cheeks, triangles |
| d) | High cheekbones or oval cheeks, symmetrical |
| 5. | Which of the below best describes your nose? |
| a) | Button nose, turned up nose, or round nose |
| b) | Curved shape down the nose, teardrop or oval shape |
| c) | Chiseled nose, angular, can create a triangle or V |
| d) | Parallel lines down the nose, or an oval down the nose or |
| | on the tip, or sharp nose |
| 6. | Which of the below best describes your eyebrows? |
| a) | Rounded, circular, or slightly pointed, short in length |
| b) | Soft curve with S shape, long in length |
| c) | Pointed, very angled, edges |
| d) | Straight across or oval |
| 7. | Which of the below best describes your eyes? |
| a) | Bright-eyed, sparkling eyes, roundish, circular, eyes pop |
| | in the center |
| b) | Almond shaped eyes, dreamy quality, heavy lidded |
| c) | Angular eye shape, exotic look, penetrating |
| d) | Oval eyes, symmetrical |
| 8. | Which of the below best describes your chin? |
| a) | Rounded smooth, little circle |
| b) | Oval, blended |
| c) | Angular, chiseled, grooves |
| d) | Oval, smooth edges |
| 9. | Which of the below best describes your hands? |
| a) | Cherub looking, tiny, youthful appearance, pillow-y |
| b) | Long hand and long fingers, tapered fingers, soft looking |
| | & smooth |
| c) | Square hand, textured knuckles, knobby joints, muscular |
| d) | Hand is rectangular, with parallel fingers from tip to |
| | hand, clear skin |
| 10. | Which of the below best describes your walking movement? |
| a) | Bouncy, perky, springy |
| b) | Graceful, flowing |
| c) | Determined, deliberate, forward motion |
| d) | Upright, poised, erect |
| 11. | Which of the below best describes your sitting style? |
| a) | Fidgety, Indian style, moves a lot (What . . . Hold still?? |
| | Impossible!!!) |
| b) | Relaxed, feet crossed at the ankles |
| c) | Tuck one leg under, leaning forward |
| d) | Sit upright, ramrod back |
| 12. | Which of the below best describes your pitch of voice? |
| a) | Light, higher in pitch, bouncy, a lot of movement in |
| | expression |
| b) | Higher, subtle, quieter, sweet, kind, soft, calming |
| c) | Lower, can be raspy or brassy sounding |
| d) | Distinct, lower, clear, distinguished, speaks the least |
| 13. | Which of the below best describes your mouth? |
| a) | Pouty, round in shape, curved shape upper lip, full bottom |
| | lip, top lip can have points |
| b) | S shaped upper lip, smooth |
| c) | Pointed upper lip, sometimes pursed or disappearing, lines |
| | around lips, prune marks |
| d) | Oval shaped mouth, sometimes forming a straight line |
| 14. | Which of the below best describes your hairline? |
| a) | high forehead, very rounded |
| b) | oval in shape |
| c) | hairline creates sharp angles or has hair grow out that |
| | creates texture/angles |
| d) | straight across, sometimes with a widow's peak |

Table 23, below, comprises additional exemplary questions that may be used in a written evaluation that is administered to a subject in order to determine the subject's own profile.

TABLE 23

| | |
|---|---|
| 1. | Which one is your greatest strength? |
| a) | Outgoing |
| b) | Tactful |
| c) | Competitive |
| d) | Good listener |
| 2. | Which one is your greatest strength? |
| a) | Persuasive |
| b) | Detail oriented |
| c) | Task oriented |
| d) | Precise |
| 3. | Which one is your greatest strength? |
| a) | Can easily adapt to others |
| b) | Peacemaker, steady influence |
| c) | Moving forward |
| d) | Firm, steadfast |
| 4. | Which one is your greatest strength? |
| a) | Motivates others |
| b) | Plan carefully |
| c) | Self starter |
| d) | Perfect the process |
| 5. | Which one is your greatest strength? |
| a) | Positive |
| b) | Compassionate |
| c) | Determined |
| d) | Pleasant |
| 6. | Which one is your greatest strength? |
| a) | Charismatic |
| b) | Intuitive |
| c) | Confident |
| d) | Sense of self-control |
| 7. | Which one is your greatest strength? |
| a) | Hopeful |
| b) | Peaceful |
| c) | Powerful |
| d) | Fair |
| 8. | Which one is your greatest strength? |
| a) | Carefree, fun-loving |
| b) | Calm, steady, supportive |
| c) | Productive, social |
| d) | Loyal, pleasant |
| 9. | Which is your greatest strength? |
| a) | Coming up with new ideas |
| b) | Pulling multiple ideas and resources together |
| c) | Putting ideas into action |
| d) | Perfecting other people's ideas |
| 10. | Which quality is your greatest strength? |
| a) | Inspire and give hope, motivate others to join |
| b) | Gather the information and create a workable plan |
| c) | Move forward; produce, get results and then share |
| d) | One on one, reflects back, provide procedures, and innately |
| | know right and wrong |
| 11. | When working on a project your gift is to: |
| a) | Jump in and give many ideas, brainstorm new info |
| b) | Connect and relate everything together - cover all the |
| | detail |
| c) | Give parts of everything, will only say what she can |
| | produce and bring to result |
| d) | Check off the list, find missing pieces, bring the result |
| | to perfection |
| 12. | Which statement most accurately describes your style when |
| | speaking before a group? |
| a) | You enthusiastically capture your audience with excitement |
| | as you present |
| b) | Your voice has a lingering melodic sound, ideas must |
| | connect and flow well. |
| c) | You move quickly from point to point in an organized manner |
| d) | You deliver a carefully prepared speech, exactly executing |
| | it as practiced. |
| 13. | When a new opportunity presents itself, you usually: |
| a) | Leave your options open and make decisions as problems |
| | arise |
| b) | Delay making a decision until all options have been |
| | thoroughly considered |
| c) | If you like the way it sounds or looks, take action |
| | immediately |
| d) | Set yourself a deadline for making a decision |
| 14. | When you walk you are: |
| a) | Light on your feet, bouncy, quick springy steps |
| b) | Slow, gliding, flowing elegantly |
| c) | Determined, leaning forward, feet firmly planted |
| d) | Smooth, erect, poised, still |
| 15. | When sitting you: |
| a) | Find it difficult to hold still, fidgets, constantly |
| | resituating body |
| b) | Tend to sink into the chair, draping over the edges, or |
| | slouching in the chair |
| c) | Usually need to bend the legs, crossing them or raising |
| | your foot up to the chair |
| d) | Straight and still, have a very proper upright frame, feet |
| | may be crossed at ankles |
| 16. | What does your personal space tend to look like: |
| a) | Everything out where you can see it, appears to be |
| | unorganized but you can find anything |
| b) | Things stacked or piled on the sidelines, yet organized |
| c) | Everything has a place and when put away, it's in its |
| | place, organized |
| d) | Everything put behind closed doors or drawers, very little |
| | out where it can be seen |
| 17. | When decorating your surroundings tend to be: |
| a) | Rooms decorated with many things to see, visually |
| | stimulating, open, airy, light |
| b) | Comfortable elegance, soft colors and textures |
| c) | Earthy comfortable feel, lots of natural elements, heavy |
| | substantial pieces |
| d) | Clean lines, very little out, contemporary style, formal |
| | style |
| 18. | When thinking your mind tends to: |
| a) | Move quickly from one thing to another, mind moves 4-5 |
| | steps ahead, great at multi-tasking |
| b) | Move over every detail taking it all in, meticulously |
| | planning everything as you go along |
| c) | Figure out ways to get started and get results quickly |
| d) | Mind finds the errors quickly and a way to solve the |
| | problem, sees the big picture and perfects it. |
| 19. | How would you best describe the first impression people |
| | have of you? |
| a) | Take notice or remember you. Say you have a sparkle in your |
| | eye. Say you're cute, perky, fun |
| b) | Think you are nice, gentle, sensitive, understanding, sweet |
| c) | Think you are sure of yourself, confident, know what you're |
| | talking about |
| d) | Think you reserved or standoff-ish (Because you don't feel |
| | the need to vocalize a lot) |
| 20. | In a team setting, people look to you to: |
| a) | See the project from many angles and offer suggestions |
| b) | Allow everyone an opportunity to voice an opinion, research |
| c) | Immediately step in and take control of the situation |
| d) | Finalize the decision so the team can move on |
| 21. | When giving your opinion on a subject, you most often: |
| a) | Try to please the majority and/or say the first thing that |
| | comes to mind |
| b) | Try to be diplomatic and not hurt anyone, careful about how |
| | to say it |
| c) | Verbalize your thoughts to make sure your opinion is heard. |
| | Give it straight without apology |
| d) | Listen intently, give an answer that is precise, and then |
| | move on. |
| 22. | When critiquing a research paper on a subject that is |
| | unfamiliar to you, you would: |
| a) | Briefly read a little, put it down and move to something |
| | else, then come back to it after a while |
| b) | Study it very thoroughly, then give recommendations in a |
| | diplomatic way. |
| c) | Scan through it rather quickly and then give an opinion. |
| d) | Look at it intently, pointing out anything that lacks |
| | perfection, then state your opinion. |
| 23. | You are most likely considered: |
| a) | impatient, mischievous, spontaneous, fun to be around |
| b) | indecisive, tenderhearted, caring, cautious |
| c) | impulsive, intense, unpredictable, demanding |
| d) | commanding, regal, focused, still |
| 24. | You tend to derive satisfaction from: |
| a) | Being light-hearted and creating and enjoyable atmosphere |
| b) | Making people feel comfortable and understood |
| c) | Accomplishing a lot and getting results |
| d) | Being right and knowledgeable |
| 25. | Of the choices below, what is most important to you? |
| a) | Leaving your options open, having the freedom to explore & |
| | discover |
| b) | Having enough information to make the best decision |
| c) | Getting to the bottom line and moving on |
| d) | Making sure things are done right |
| 26. | What clothing style most appeals to you? |
| a) | Spunky, fun, flirty, tailored and/or trendy (most variety |
| | of styles) |
| b) | Comfortable, cozy with a touch of elegant, vintage |
| c) | Invigorating, exciting, easy to move in, casual |
| d) | Contemporary, clean lines, sophisticated, stylized, |
| | noticeable, make a statement |
| 27. | When doodling you tend to draw: |
| a) | Circles, spirals, triangles, stars, sunburst —upward & |
| | outward lines |
| b) | Soft flowing lines, teardrops and ovals |
| c) | Geometric shapes, angles, lots of edges with quick, sharp |
| | turns |
| d) | Doodle . . . who doodles? |
| 28. | What way do you relax and pamper yourself? |
| a) | Talk to a close friend on the phone (social & interactive) |
| b) | Take a soothing candlelit bath, read or go on a walk |
| | (experience & romance) |
| c) | Do an activity: hike, bike, craft (produce & move) |
| d) | Meditate, read a book, be alone (reflection & stillness) |
| 29. | Another way to enjoy yourself would be: |
| a) | Going with friends, play, participate in fun activities, |
| | interaction |
| b) | Going to museums, learning, cultural activities |
| c) | Must have a point, reach a goal, must accomplish something |
| d) | Retreat of learning, place to gain knowledge and reflect |
| 30A. | Do your energy and actions relate more to: |
| | a) hummingbird b) dove c) hawk d) swan |
| 30B. | Do your energy and actions relate more to: |
| | a) babbling brook b) winding river c) crashing waves |
| | d) frozen still pond |
| 30C. | Do your energy and actions relate more to: |
| | a) aspen trees shimmering b) weeping willow c) mighty oak |
| | d) noble fir |
| 30D. | Do your energy and actions relate more to: |
| | a) geysers b) rolling hills c) mesas, mtns d) icicles |
| 31. | Of the following irritating scenarios, which would bother |
| | you the most? |
| a) | Being forced to sit still for a long period of time and |
| | listening to long, detailed explanations |
| b) | Working for someone who changes the direction of the |
| | company and your responsibilities. |
| c) | Forced to follow a procedure and system that was developed |
| | by someone else without your input. |
| d) | Having no system to use or vision of what the completed |
| | project would look like. |
| 32. | When taking action on a project you tend to: |
| a) | Talk first, think later |
| b) | Ask many questions |
| c) | Act first, ask questions later |
| d) | Be contemplative |

It will be appreciated the questions in Tables 22 and 23 are exemplary only and that other questions may be derived to determine a subject's personal attributes by those skilled in the art using the present disclosure.

As mentioned, the results of the evaluation, such as the written evaluations in Tables 22 and 23 above, may determine a subject's own attributes. Once a subject's own attributes have been determined, they may be compared to the attributes of the predefined profiles, i.e., the Type 1, Type 2, Type 3 and Type 4 profile classifications. In particular, it is determined which of the Type 1, Type 2, Type 3, and Type 4 profile classifications has the attributes that most closely match the subject's personal attributes as determined by the evaluation. The subject is then assigned to that predefined profile with the attributes that most closely match the subject's personal attributes as determined by the evaluation. This is the subject's dominate predefined profile. In addition, the subject may be assigned a subordinate predefined profile from one of the predefined profiles.

Once the subject has been matched to one of the predefined profiles, the subject is presented with information on the appearance enhancement plan that corresponds to that predefined profile. The information on the appearance enhancement plan may be presented orally or in writing. In addition, the information on the appearance enhancement plan may include visual elements, such as examples, photographs, product samples and the like. As previously explained, the appearance enhancement plan will assist the subject in improving his or her overall physical appearance. This in turn, will also likely improve the subject's self-image and attitude.

Prior to taking a self-evaluation, a subject may undergo an introductory session explaining the general concepts of the predefined profiles and their related characteristics. In addition, the information in FIGS. 11-16 may be presented to the subject in order to heighten the subject's understanding of the attributes of each of the predefined profiles. Once the subject's predefined profile has been determined, the subject may receive additional information on implementing the appropriate appearance enhancement plan.

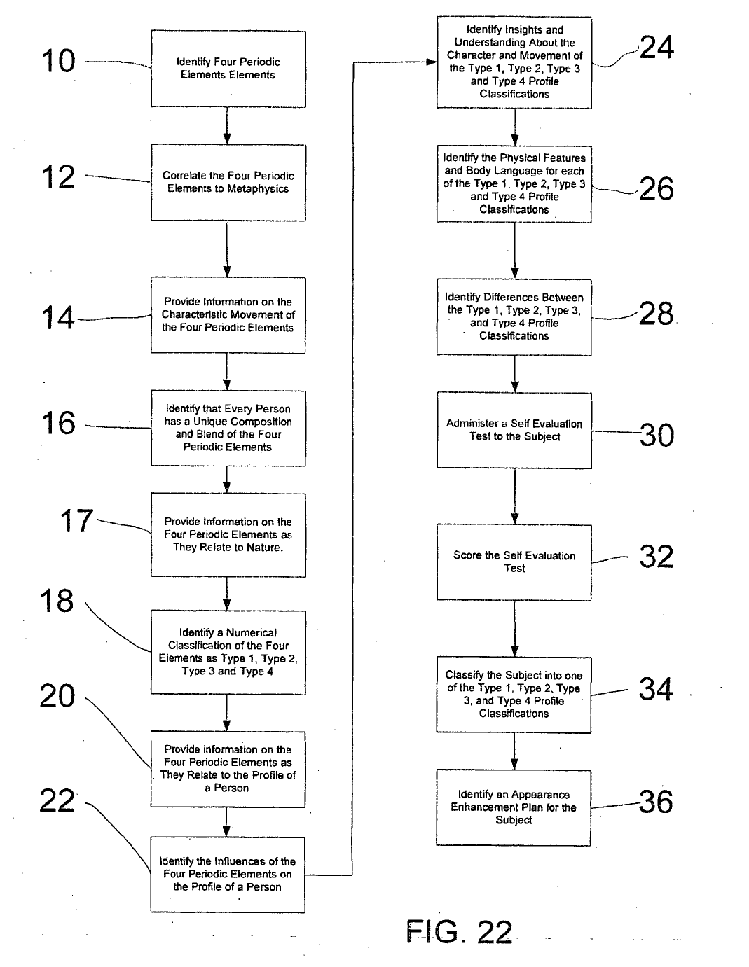

Referring now to FIG. 22, there is shown a flow diagram illustrating an exemplary embodiment of a method in accordance with the principles of the present disclosure. Step 10 involves presenting a subject with information on the four representative periodic elements for the Type 1, Type 2, Type 3, and Type 4 profile classifications as shown in Table 11 (FIG. 11). These elements are found on the periodic table and may consist of Nitrogen, Oxygen, Hydrogen, and Carbon. At step 12, the subject is presented with information regarding the correlation of each of these four periodic elements to metaphysics. (Metaphysics is the branch of philosophy that examines the nature of reality, including the relationship between mind and matter, substance and attribute, fact and value.) In particular, the subject is presented with information that, from a metaphysical viewpoint, Nitrogen correlates to Air, Oxygen correlates to Water, Hydrogen correlates to Fire, and Carbon correlates to Earth, as is shown in Table 11 (FIG. 11).

At step 14 (FIG. 22), the subject is presented with information on a characteristic movement of each of the four periodic elements. In particular, the subject is presented with information that: Nitrogen/Air correlates to upward and light energy; Oxygen/Water correlates to fluid and flowing energy; Hydrogen/Fire correlates to active and reactive energy; and Carbon/Earth correlates to constant and still energy as is shown in Table 11 (FIG. 11).

At step 16, the subject is presented with information that every person has a unique composition and blend of the four periodic elements identified at step 10. That is, the subject is presented with information that every human being has a unique composition and blend of the four periodic elements in different amounts and sequences. The subject is presented with information that some people, for example, have more Carbon and lessor amounts of the other three elements and that some people may even have two or three of the periodic elements that are dominant in their beings. At step 17, information is provided to the subject regarding the relationships between each of the four periodic elements and nature. For example, the subject is presented with information that: Nitrogen relates to aspen trees, babbling brooks, rolling hills, and hummingbirds; Oxygen relates to the Mississippi River, caterpillars, and doves; Hydrogen relates to rugged landscapes, tigers and hawks; and Carbon relates to icicles, frozen ponds, black panthers, and swans.

At step 18, the subject is introduced to a numerical classification for the four periodic elements and the metaphysical energy that they each represent is also identified. In particular, the subject is presented with information that Nitrogen/Air is a Type 1 profile, Oxygen/Water is a Type 2 profile, Hydrogen/Fire is a Type 3 profile, and Carbon/Earth is a Type 4 profile. It is further presented to the subject that: Nitrogen/Air has an upward, light energy; Oxygen/Water has a fluid, flowing energy; Hydrogen/Fire has an active, reactive energy; and that Carbon/Earth has a constant, still energy. At step 20, the subject is presented with additional information on each of the Type 1, Type 2, Type 3, and Type 4 profile classifications. This may involve presenting charts, tables and diagrams showing: (a) The name of the four different profile classifications in both chemical and metaphysical terms; (b) Words that describe the characteristics of the vibration and movement of the four profile classifications; (c) Showing what the flow of the energy looks like for the four profile classifications; (d) Showing the shapes and the lines that represent the energies of the four different profile classifications; (e) Showing the movement of the energies of the four different profile classifications; and (f) Showing the YIN/YANG of each of the four different profile classifications. Each of these will be further described below.

In regard to the name each of the Type 1, Type 2, Type 3, and Type 4 profile classifications in both elemental and metaphysical terms, the information found in Table 11 (FIG. 11) may be presented to the subject. Next, in regard to exemplary words that describe the characteristics of the vibration and movement for each of the Type 1, Type 2, Type 3, and Type 4 profile classifications, the information found in Table 12 (FIG. 12) may be presented to a subject. In regard to shapes and lines that represent the Type 1, Type 2, Type 3, and Type 4 profile classifications, the information found in Table 13 (FIG. 13) may be presented to a subject. For the energy movement of the Type 1, Type 2, Type 3, and Type 4 profile classifications, the information presented to the subject may include a diagram similar to that found in Table 14 (FIG. 14). Finally, the Yin/Yang relationships of the Type 1, Type 2, Type 3, and Type 4 profile classifications may be presented to the subject pursuant to the information in Table 15 (FIG. 15).

At step 22, the influences on the personality and behavior of persons of each of the Type 1, Type 2, Type 3, and Type 4 profile classifications are identified to the subject. This may include identifying (a) the gift of each of the Type 1, Type 2, Type 3, and Type 4 profile classifications; (b) the personality traits of each of the Type 1, Type 2, Type 3, and Type 4 profile classifications; (c) behavior tendencies of each of the Type 1, Type 2, Type 3, and Type 4 profile classifications; and (d) how each of the Type 1, Type 2, Type 3, and Type 4 profile classifications influences the brain.

In regard to identifying the gifts and talents of each of the Type 1, Type 2, Type 3, and Type 4 profile classifications, the subject may be presented with the information in Table 4 (FIG. 4). Next, the subject may be presented with the information in Table 5 (FIG. 5) on how each of the Type 1, Type 2, Type 3, and Type 4 profile classifications influences the brain and thought processes of a person. Next, the subject may be presented the information contained in Table 3 (FIG. 3) on how each of the Type 1, Type 2, Type 3, and Type 4 profile classifications has its own personality and behavioral tendencies.

At step 24, further insights and understanding about the character and movement of each of the Type 1, Type 2, Type 3, and Type 4 profile classifications are presented to the subject, which may include the information in the “Insights” column of Table 11 (FIG. 11). At step 26, the physical features and body language for each of the Type 1, Type 2, Type 3, and Type 4 profile classifications are presented to the subject. This may include presenting the information in Tables 1 and 2, respectively, and the information in Table 10. At step 28, the subject may be presented with information on the differences of each of the Type 1, Type 2, Type 3, and Type 4 profile classifications, including comparing and contrasting the information in Tables 1-10 (FIGS. 1-10), respectively.

It will be appreciated that the purpose of the foregoing steps 10-28 is to adequately prepare the subject to determine his or her own personal attributes as will now be explained. At step 30, a self-evaluation test is administered to the subject. The purpose of the self-evaluation is to gather information about the subject's personal attributes for the characteristics that define the predefined profiles. The self-evaluation test should be designed to assist the subject in determining his or her dominant and subordinate predefined profiles from the Type 1, Type 2, Type 3, and Type 4 profile classifications. It will be appreciated that the Type 1, Type 2, Type 3, and Type 4 profile classifications may be considered predefined profiles. As mentioned, the self-evaluation test is preferably administered after the subject has received some or all of the information in Tables 1-16 so that the subject is adequately prepared for the self-evaluation test.

Before the self-evaluation test is administered, the subject may be instructed that the test is a self-administered test and should not be discussed with anyone else. The subject may further be instructed that there are no right or wrong answers to the test. The subject may further be instructed that if he or she cannot choose just one answer, that the subject should choose all the answers that are applicable, and if none of the answers seems to fit, then none should be chosen. Because of the nature of the information, it is important that the subject determine his or her own profile based upon the information presented him or her. However, although less desirable, it is within the scope of the present disclosure, that a third party determine the personal profile of a person. Ideally, the third party only facilitates the process.

The self-evaluation test may comprise groupings of words that “best describe” the subject. The subject may be allowed to choose from among the groupings, the grouping of words that best describes him or her. The self-evaluation assessment may further comprise a body profile assessment. An exemplary body profile assessment is found in Table 22, above. The body profile assessment may ask the subject to determine if he or she has any of the attributes identified in Tables 1, 2 and 10 (FIGS. 1,2 and 10). The self-evaluation assessment may further comprise a personality and behavior assessment. An exemplary personality and behavior assessment is found in Table 23, above. The exemplary personality and behavior assessment may ask the person to determine if he or she has any of the personality traits or behaviors, identified in Tables 3, 4, and 5 (FIGS. 3,4 and 5).

After the self-evaluation test has been completed by the subject, the test is scored at Step 32. The purpose of the scoring is to determine which attributes the subject has in relation to each of the Type 1, Type 2, Type 3, and Type 4 profile classifications. From the self-evaluation test, a subject's dominate and subordinate profiles can be determined based upon the subject's answers as shown at Step 34. For example, if the subject's answers fall predominately in Type 1, then the subject may be classified as a Type 1. Once a subject's personal profile has been matched to one of the Type 1, Type 2, Type 3, and Type 4 profile classifications, the subject may optionally be provided with information, outlined below, describing his or her profile so that the subject better understands his or her own character. This may include the information in Tables 6-9 (FIGS. 6-9).

Once the subject has been classified into one of the Type 1, Type 2, Type 3, or Type 4 profile classifications, an appearance enhancement plan is presented, created, or provided to the subject as shown in Step 36. The appearance enhancement plan typically comprises some or all of the information in Tables 17A-21B. The appearance enhancement plan may serve as a guide to the subject about how to dress according the subject's profile.

Those having ordinary skill in the relevant art will appreciate the advantages provide by the features of the present disclosure. For example, it is a feature of the present disclosure to provide a method for improving the appearance of a subject based upon the subject's profile.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of any a single foregoing disclosed embodiment. Thus, the following claims are hereby incorporated into this Detailed Description by this reference, with each claim standing on its own as a separate embodiment of the present disclosure.

Further, it is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for image enhancement, said system comprising:
a plurality of predefined profiles, the plurality of predefined profiles having a plurality of characteristics in common with each other;
each of the plurality of predefined profiles having a unique attribute associated with each of the plurality of characteristics;
a plurality of appearance enhancement plans, each of the plurality of appearance enhancement plans corresponding to one of the plurality of predefined profiles;
an evaluation for determining one or more personal attributes of a human subject for each of the plurality of characteristics;
wherein the human subject is matched to one of the predefined profiles based upon the one or more personal attributes of the human subject as determined by the evaluation; and
wherein an image of the human subject is improved through implementation of the appearance enhancement plan corresponding to the predefined profile to which the human subject has been matched.

2. The system of claim 1, wherein the plurality of characteristics comprises at least one of skin appearance, face shape, cheek appearance, nose appearance, eyebrow appearance, eye appearance, and hand appearance.

3. The system of claim 1, wherein the plurality of characteristics comprises body language of a human being.

4. The system of claim 3, wherein the body language comprises at least one of a walking manner, a sitting manner, a standing manner, a voice pitch, a doodling tendency, and a personal space tendency.

5. The system of claim 1, wherein the plurality of characteristics comprises behavioral tendencies.

6. The system of claim 1, wherein the plurality of characteristics comprises personality tendencies.

7. The system of claim 1, wherein the plurality of characteristics comprises physical features of a human being.

8. The system of claim 1, wherein the plurality of characteristics comprises gifts of a human being.

9. The system of claim 1, wherein the plurality of characteristics comprises talents of a human being.

10. The system of claim 1, wherein the plurality of characteristics comprises brain and thought processes of a human being.

11. The system of claim 1, wherein each of the plurality of predefined profiles is correlated to one of a plurality of periodic elements.

12. The system of claim 11, wherein the plurality of periodic elements comprises Nitrogen, Oxygen, Hydrogen, and Carbon.

13. The system of claim 1, wherein each of the plurality of predefined profiles is correlated to one of a plurality of metaphysical elements.

14. The system of claim 13, wherein the plurality of metaphysical elements comprises air, water, fire, and earth.

15. The system of claim 1, wherein the evaluation is a written evaluation.

16. The system of claim 1, wherein the evaluation is administered to the human subject over a computer network.

17. The system of claim 1, wherein the evaluation is a self-evaluation.

18. The system of claim 1, wherein each of the plurality of appearance enhancement plans comprises information on at least one of design lines, fabric texture, material fabrication, patterns, and colors.

19. The system of claim 1, wherein each of the plurality of appearance enhancement plans comprises information on hairstyle and hair color.

20. The system of claim 1, wherein each of the plurality of appearance enhancement plans comprises information selected from the group consisting of: make-up application and skin care.

21. The system of claim 1, wherein each of the plurality of appearance enhancement plans comprises information on accessories.

22. The system of claim 1, wherein each of the plurality of appearance enhancement plans comprises information on jewelry.

23. A method of improving an image of a human subject, said method comprising:
defining a plurality of predefined profiles, the plurality of predefined profiles having a plurality of characteristics in common with each other, each of the plurality of predefined profiles having a unique attribute associated with each of the plurality of characteristics;
defining a plurality of appearance enhancement plans, each of the plurality of appearance enhancement plans corresponding to one of the plurality of predefined profiles; and
defining an evaluation to thereby determine one or more attributes of the human subject for each of the plurality of characteristics.

24. The method of claim 23, further comprising the step of administering the evaluation to the human subject.

25. The method of claim 24, further comprising the step of comparing the one or more attributes of the human subject as determined by the evaluation to the unique attributes associated with each of the plurality of characteristics.

26. The method of claim 25, further comprising the step of associating the human subject to one of the predefined profiles.

27. The method of claim 26, further comprising the step of presenting the human subject with the appearance enhancement plan that corresponds to the predefined profile to which the human subject is matched.

28. The method of claim 23, wherein the plurality of characteristics comprises at least one of skin appearance, face shape, cheek appearance, nose appearance, eyebrow appearance, eye appearance, and hand appearance.

29. The method of claim 23, wherein the plurality of characteristics comprises body language of a human being.

30. The method of claim 29, wherein the body language comprises at least one of a walking manner, a sitting manner, a standing manner, a voice pitch, a doodling tendency, and a personal space tendency.

31. The method of claim 23, wherein the plurality of characteristics comprises behavioral tendencies.

32. The method of claim 23, wherein the plurality of characteristics comprises personality tendencies.

33. The method of claim 23, wherein the plurality of characteristics comprises physical features of a human being.

34. The method of claim 23, wherein the plurality of characteristics comprises gifts of a human being.

35. The method of claim 23, wherein the plurality of characteristics comprises talents of a human being.

36. The method of claim 23, wherein the plurality of characteristics comprises brain and thought processes of a human being.

37. The method of claim 23, wherein each of the plurality of appearance enhancement plans comprises information on at least one of design lines, fabric texture, material fabrication, patterns, and colors.

38. The method of claim 23, wherein each of the plurality of appearance enhancement plans comprises information on hairstyle and hair color.

39. The method of claim 23, wherein each of the plurality of appearance enhancement plans comprises information on make-up application.

40. The method of claim 23, wherein each of the plurality of appearance enhancement plans comprises information on accessories.

41. The method of claim 23, wherein each of the plurality of appearance enhancement plans comprises information on jewelry.
